(19) United States
(12) Patent Application Publication
(10) Pub. No.: US 2026/0253784 A1
(43) Pub. Date: Aug. 27, 2026

(54) CHOKE STRUCTURE

(71) Applicant: TAI-TECH ADVANCED ELECTRONICS CO., LTD., Taoyuan City (TW)

(72) Inventors: Cheng-Han YU, Taoyuan City (TW); Pao-Lin SHEN, Taoyuan City (TW); Ming-Yen HSIEH, Taoyuan City (TW)

(21) Appl. No.: 19/059,332

(22) Filed: Feb. 21, 2025

(51) Int. Cl. H01F 27/28; H01F 27/255

(52) U.S. Cl. CPC H01F 27/28; H01F 27/255

(57) ABSTRACT

The choke includes a coil and a body. The coil defines a first axial direction and a second axial direction that are perpendicular to each other, and the coil includes multiple first, third, and fifth leads along the first axial direction, multiple second, fourth, and sixth leads along the second axial direction, and a seventh lead along the first axial direction. The first leads are respectively connected to the second leads, the second leads are respectively connected to the third leads, the third leads are respectively connected to the fourth leads, the fourth leads are respectively connected to the fifth leads, the fifth leads are respectively connected to the sixth leads, and the sixth leads are respectively connected to the seventh lead. The body includes a magnetic material and encloses the coil with the first leads arranged and exposed outside the body.

### BACKGROUND OF THE INVENTION

### (a) Technical Field of the Invention

The present invention generally relates to inductors, and more particularly to a choke.

### (b) Description of the Prior Art

A choke is a type of inductor typically composed of a coil wound around a magnetic core, capable of suppressing changes in alternating current (ripple current).

For example, the Republic of China, Taiwan, Patent No. I789230 describes an “inductor with a high-current coil and low DC resistance.” This inductor includes a coil formed by a conductor with a winding shape, which may have an “S” shape. The coil features two lead wires extending from opposite ends of the coil. An inductor body surrounds the coil and parts of the lead wires. These lead wires can be wound around the body to create contact points on the exterior of the inductor.

However, referring to FIG. 27 of Patent No. I789230, the exposed lead wires on both sides of the body account for approximately 20% of the overall coil. These exposed portions do not contribute to inductance, leading to low utilization efficiency. Adjusting the leads to be fully enclosed within the body could affect the “S” shape of the coil, thereby reducing inductance and current-handling capacity.

### SUMMARY OF THE INVENTION

To obviate the above shortcoming, the present invention discloses a choke, which choke includes a coil and a body. The coil defines a first axial direction and a second axial direction that are perpendicular to each other, and the coil includes first leads along the first axial direction, second leads along the second axial direction, third leads along the first axial direction, fourth leads along the second axial direction, fifth leads along the first axial direction, sixth leads along the second axial direction, and a seventh lead along the first axial direction. The first leads are respectively end-to-end connected to the second leads, the second leads are respectively end-to-end connected to the third leads, the third leads are respectively end-to-end connected to the fourth leads, the fourth leads are respectively end-to-end connected to the fifth leads, the fifth leads are respectively end-to-end connected to the sixth leads, and the sixth leads are respectively end-to-end connected to the seventh lead. The body includes a magnetic material and encloses the coil with the first leads arranged and exposed outside the body.

Specifically, the first leads have a length that is shorter than that of the third leads.

Specifically, the first leads are extended toward or away from each other.

Specifically, the second leads have a length that is greater than that of the fourth leads.

Specifically, the magnetic material is at least one or a combination of carbonyl iron powder (CIP), alloy iron powder, amorphous powder, nanocrystalline material, or sintered magnetic material.

In summary, the choke of the present invention modifies the lengths of the third leads and fifth leads to alter the areas of the multiple regions defined by the first leads, second leads, third leads, fourth leads, fifth leads, sixth leads, and seventh lead, thereby adjusting the magnetic flux and, in turn, tuning the inductance and enhancing current-handling capability.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a choke according to a first embodiment of the present invention.

FIG. 2 is a sectional diagram showing the choke of FIG. 1.

FIG. 3 is a sectional diagram showing a choke according to a second embodiment of the present invention.

FIG. 4 is a sectional diagram showing a choke according to a third embodiment of the present invention.

FIG. 5 depicts the relationship between the length of the third and fifth leads and the produced inductance in the choke of the present invention.

FIG. 6 is a sectional diagram showing a choke according to a fourth embodiment of the present invention.

FIG. 7 is a sectional diagram showing a choke according to a fifth embodiment of the present invention.

FIG. 8 is a sectional diagram showing a choke according to a sixth embodiment of the present invention.

FIG. 9 depicts the relationship between the area ratio and the produced inductance in the choke of the present invention.

FIG. 10 compares AC impedance between the choke of the present invention and a conventional inductor under different frequencies.

FIG. 11 compares the produced inductance between the choke of the present invention and a conventional inductor under different magnetic permeabilities.

FIG. 12 compares the produced inductance between the choke of the present invention and a conventional inductor under different DC biases.

FIG. 13 is a sectional diagram showing a choke according to a seventh embodiment of the present invention.

FIG. 14 is a perspective diagram showing a choke according to an eighth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

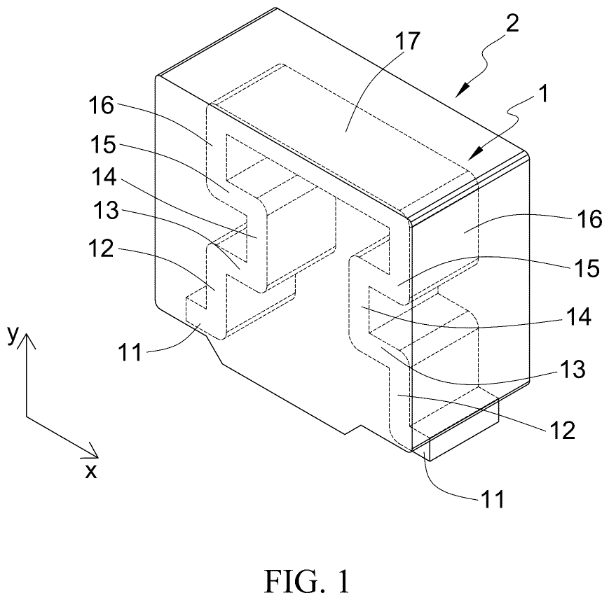

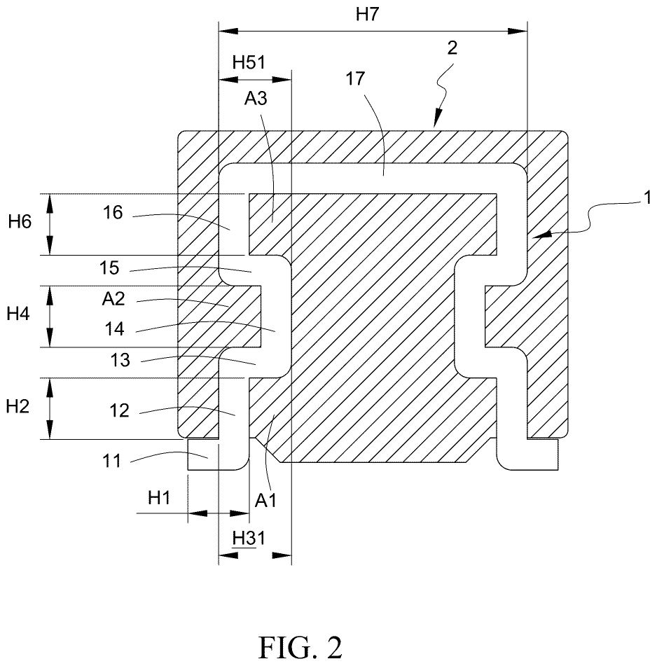

As shown in FIGS. 1 and 2, a choke according to a first embodiment of the present invention includes the following components.

A coil 1 defines a first axial direction X and a second axial direction Y that are perpendicular to each other. The coil 1 includes multiple first leads 11 along the first axial direction X, multiple second leads 12 along the second axial direction Y, multiple third leads 13 along the first axial direction X, multiple fourth leads 14 along the second axial direction Y, multiple fifth leads 15 along the first axial direction X, multiple sixth leads 16 along the second axial direction Y, and a seventh lead 17 along the first axial direction X. The first leads 11 are respectively end-to-end connected to the second leads 12, the second leads 12 are respectively end-to-end connected to the third leads 13, the third leads 13 are respectively end-to-end connected to the fourth leads 14, the fourth leads 14 are respectively end-to-end connected to the fifth leads 15, the fifth leads 15 are respectively end-to-end connected to the sixth leads 16, and the sixth leads 16 are respectively end-to-end connected to the seventh lead 17.

A body 2 contains a magnetic material, which is formed around and encloses the coil 1 with the first leads 11 arranged and exposed outside the outer side 21 of the body 2. The magnetic material can be carbonyl iron powder (CIP), alloy iron powder, amorphous powder, nanocrystalline material, or sintered magnetic material. CIP is a high-purity iron powder that, during the low-temperature curing process, can serve as a filler to enhance the material's mechanical properties and wear resistance. Alloy iron powder refers to powdered materials composed of iron mixed with other alloying elements such as carbon, nickel, chromium, or copper. Examples include Fe—Si—Cr alloy or Fe—Si alloy. Fe—Si—Cr alloy is an alloy of iron (Fe), silicon (Si), and chromium (Cr), which enhances material strength and corrosion resistance. Fe—Si alloy is an alloy of iron (Fe) and silicon (Si) that improves magnetic properties and electrical conductivity. Amorphous powder refers to powdered materials with an irregular atomic arrangement. It typically exhibits excellent strength, toughness, and corrosion resistance. An example is the Fe—Si—Cr—B—C alloy, which combines iron (Fe), silicon (Si), chromium (Cr), boron (B), and carbon (C). This alloy can form an amorphous structure during rapid cooling. Sintered magnetic materials include alloys such as Fe—Si—Al, Fe—Si—Mo, Fe—Ni, Fe—Si, or Mn—Zn alloys. Sintering is a process where powdered materials are heated to near their melting point to promote particle bonding, resulting in a dense solid material. For instance, Fe—Si—Al alloy can be sintered in powder form to produce high-performance magnetic materials.

As shown in FIG. 2, the length H1 of the first leads 11 is shorter than the length H31 of the third leads 13. The multiple first leads 11 serve as connection terminals. The length H2 of the second leads 12 is greater than the length H4 of the fourth leads 14.

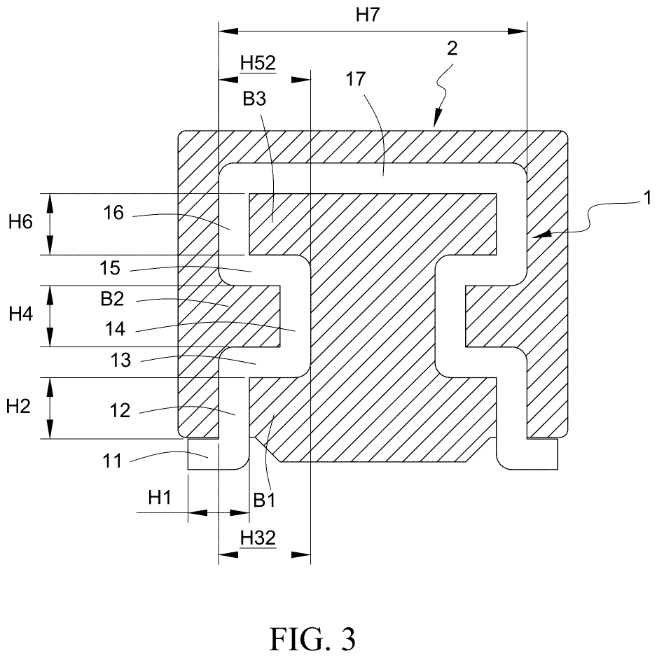

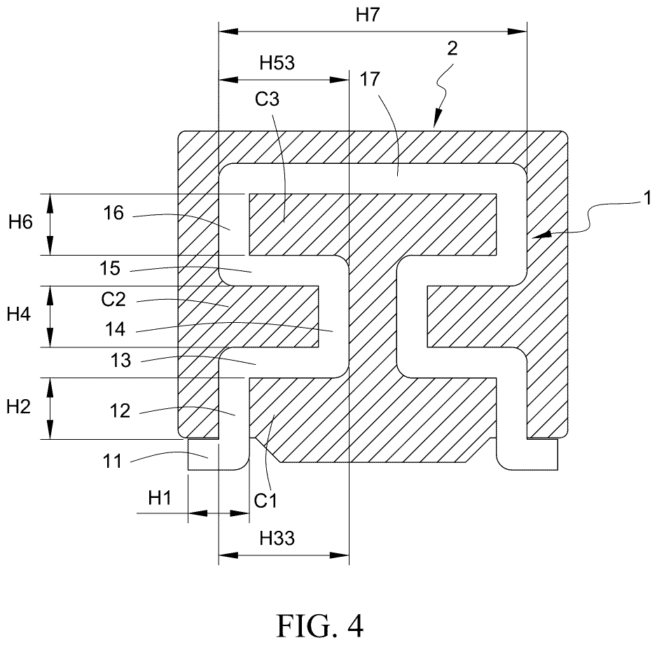

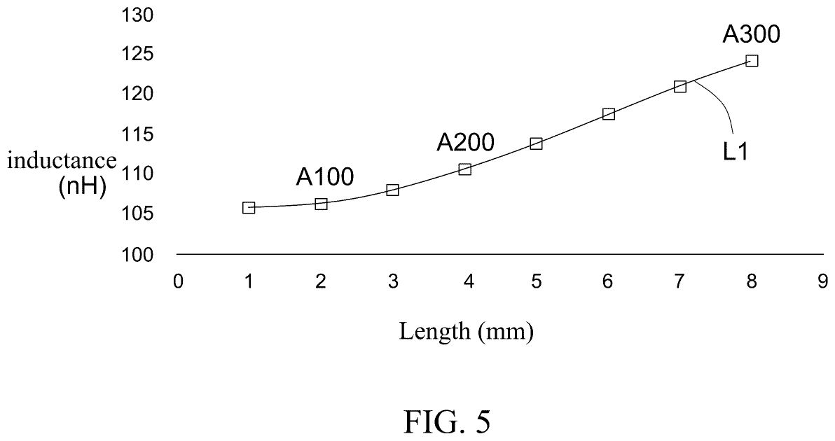

As illustrated in FIG. 2, the first leads 11, second leads 12, third leads 13, fourth leads 14, fifth leads 15, sixth leads 16, and seventh lead 17 jointly defines three regions A1, A2, and A3 inside the body 2. Similarly, in a second embodiment shown in FIG. 3, the same leads define three regions B1, B2, and B3 inside the body 2. In a third embodiment shown in FIG. 4, they similarly define three regions C1, C2, and C3. In FIGS. 2, 3, and 4, the lengths of the first leads 11 (H1), second leads 12 (H2), fourth leads 14 (H4), and sixth leads 16 (H6) remain constant, but the lengths of the third leads 13 (H31, H32, H33) and the lengths of the fifth leads 15 (H51, H52, H53) vary. Therefore, the areas of regions A1, A2, A3, B1, B2, B3, C1, C2, and C3 are varied in these embodiments, thereby modifying the magnetic flux (the number of magnetic field lines passing perpendicularly through a given area) and further tuning the inductance and current-carrying capacity of the choke. Refer to FIG. 5. The horizontal axis represents the length of the third and fifth leads 13 and 15, measured in millimeters (mm), and the vertical axis represents the inductance, measured in nanohenries (nH). Along the curve L1, A100 represents the inductance of the choke of FIG. 2, A200 represents the inductance of the choke of FIG. 3, and A300 represents the inductance of the choke of FIG. 4. As indicated, when the lengths H31 and H51 of the third and fifth leads 13 and 15 are adjusted to 2 mm, the overall inductance is approximately 108 nH, when the lengths H32 and H52 are adjusted to 4 mm, the overall inductance is approximately 112 nH, and when the lengths H33 and H53 are adjusted to 8 mm, the overall inductance is approximately 124 nH.

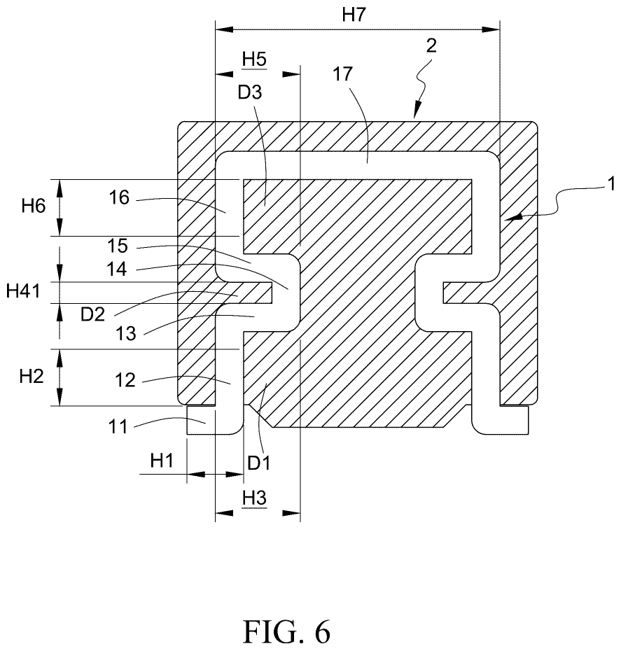

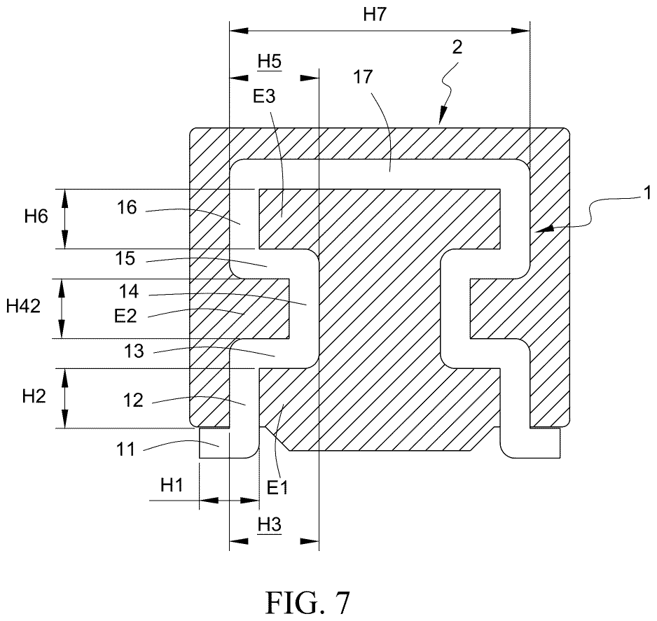

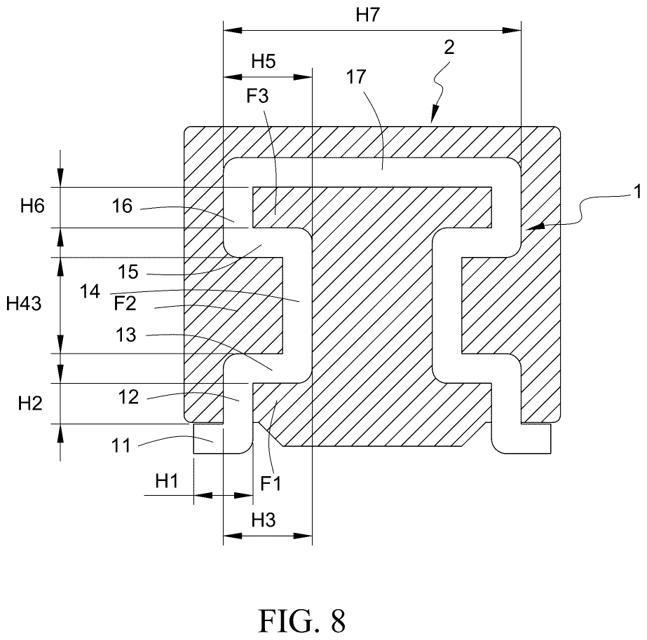

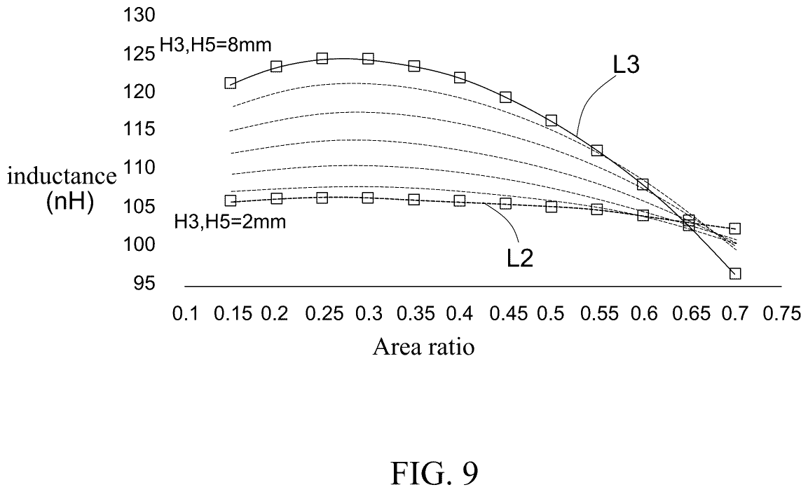

In a fourth embodiment illustrated in FIG. 6, the first leads 11, second leads 12, third leads 13, fourth leads 14, fifth leads 15, sixth leads 16, and seventh lead 17 jointly define three regions D1, D2, and D3 inside the body 2. In a fifth embodiment shown in FIG. 7, the same leads define three regions E1, E2, and E3. In a sixth embodiment shown in FIG. 8, they define three regions F1, F2, and F3. In these embodiments, the lengths of the first leads 11 (H1), second leads 12 (H2), third leads 13 (H3), fifth leads 15 (H5), and sixth leads 16 (H6) remain constant, but the lengths of the fourth lead 14 (H41, H42, H43) vary. By adjusting the areas of regions D1, D2, D3, E1, E2, E3, F1, F2, and F3, the magnetic flux can be modified, thereby tuning the inductance. Refer to FIG. 9. The horizontal axis represents the area ratio, and the vertical axis represents the inductance, measured in nanohenries (nH). Curve L2 illustrates the relationship between the area ratio and inductance when the lengths of the third and fifth leads 13 (H3) and 15 (H5) are both 2 mm, and the lengths of the fourth leads 14 (H41, H42, H43) are adjusted. Curve L3 illustrates the same relationship when the lengths of the third and fifth leads 13 (H3) and 15 (H5) are both 8 mm, and the lengths of the fourth leads 14 (H41, H42, H43) are adjusted. From FIG. 9, it can be observed that when the area ratio is 0.275, the inductance value is 124 nH, representing the optimal solution.

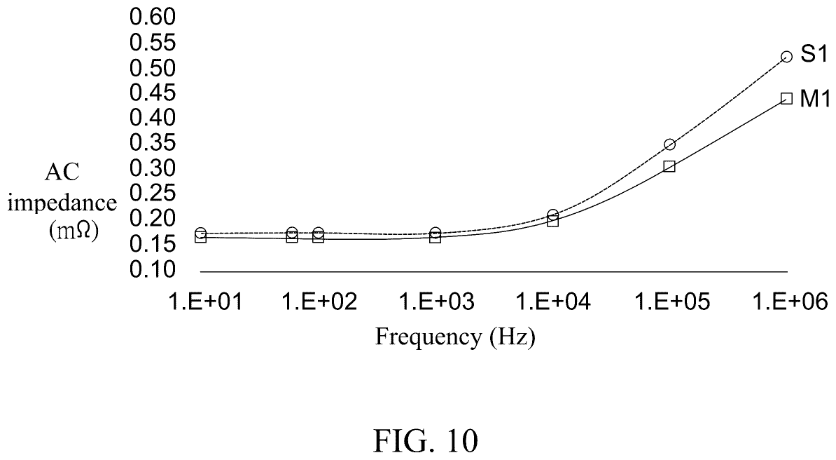

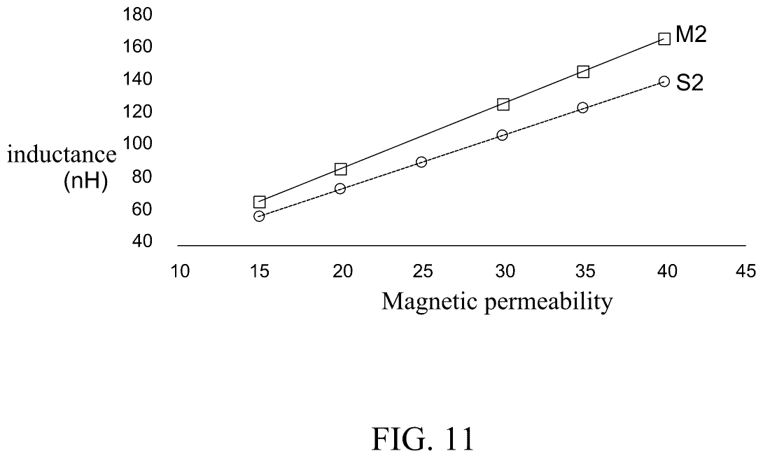

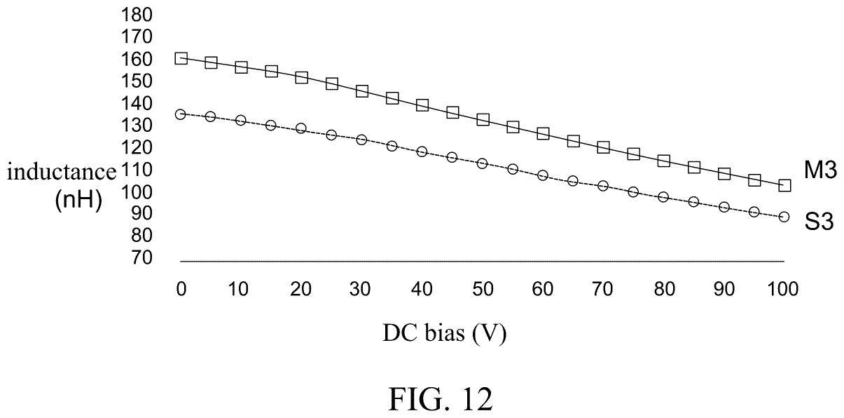

Additionally, the performance of the choke of the present invention can be compared with that of conventional inductors. Refer to FIG. 10, where the horizontal axis represents frequency (in Hertz, Hz) and the vertical axis represents AC impedance (in milliohms, mΩ). Curve S1 corresponds to a conventional inductor, while curve M1 corresponds to the choke of the present invention. From FIG. 10, it can be observed that, at the same frequency (i.e., with the same DC resistance), the choke of the present invention exhibits lower AC impedance compared to the conventional inductor. Refer to FIG. 11, where the horizontal axis represents magnetic permeability, and the vertical axis represents inductance (in nanohenries, nH). Curve S2 corresponds to a conventional inductor, while curve M2 corresponds to the choke of the present invention. From FIG. 11, it can be seen that, at the same magnetic permeability, the inductance of the choke of the present invention is improved by 16% to 20% compared to the conventional inductor. Refer to FIG. 12, where the horizontal axis represents DC bias (in volts, V) and the vertical axis represents inductance (in nanohenries, nH). Curve S3 corresponds to a conventional inductor, while curve M3 corresponds to the choke of the present invention in this case. From FIG. 12, it can be observed that, under similar DC resistance, the choke of the present invention provides higher inductance and better current-handling capability.

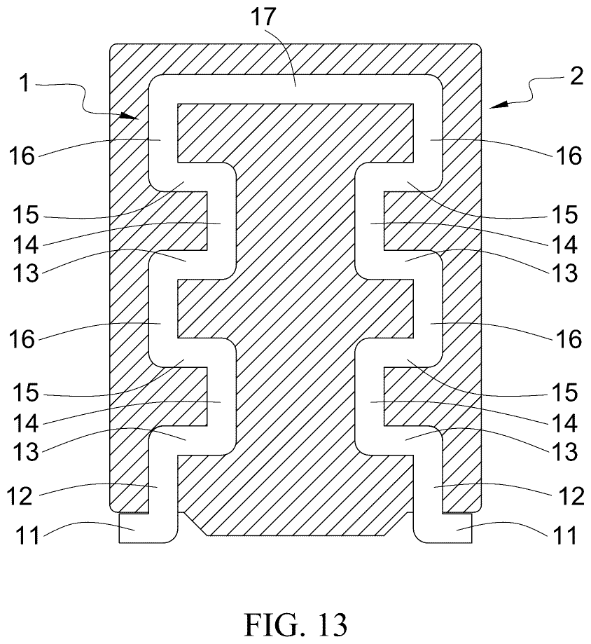

As shown in FIG. 13, in a seventh embodiment of the present invention, the coil 1 can be vertically extended to include additional third leads 13, fourth leads 14, fifth leads 15, and sixth leads 16.

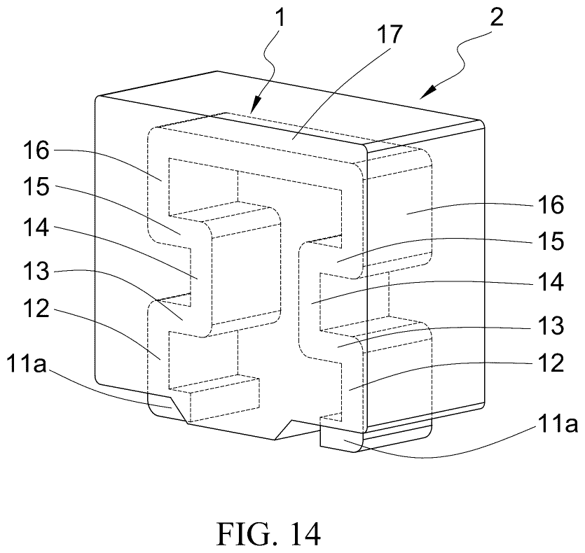

As shown in FIG. 14, in an eighty embodiment of the present invention, the exposed first leads 11a are extended laterally away from each other, while, in the first embodiment shown in FIG. 1, they are extended laterally toward each other.

In summary, the choke of the present invention modifies the lengths of the third leads 13 (H31, H32, H33) and fifth leads 15 (H51, H52, H53) to alter the areas of the multiple regions defined by the first leads 11, second leads 12, third leads 13, fourth leads 14, fifth leads 15, sixth leads 16, and seventh lead 17, thereby adjusting the magnetic flux and, in turn, tuning the inductance.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A choke, comprising:
a coil defining a first axial direction and a second axial direction that are perpendicular to each other, and comprising a plurality of first leads along the first axial direction, a plurality of second leads along the second axial direction, a plurality of third leads along the first axial direction, a plurality of fourth leads along the second axial direction, a plurality of fifth leads along the first axial direction, a plurality of sixth leads along the second axial direction, and a seventh lead along the first axial direction, where the first leads are respectively end-to-end connected to the second leads, the second leads are respectively end-to-end connected to the third leads, the third leads are respectively end-to-end connected to the fourth leads, the fourth leads are respectively end-to-end connected to the fifth leads, the fifth leads are respectively end-to-end connected to the sixth leads, and the sixth leads are respectively end-to-end connected to the seventh lead;
a body comprising a magnetic material and enclosing the coil with the first leads arranged and exposed outside the body.

2. The choke according to claim 1, wherein the first leads have a length that is shorter than that of the third leads.

3. The choke according to claim 1, wherein the first leads are extended toward or away from each other.

4. The choke according to claim 1, wherein the second leads have a length that is greater than that of the fourth leads.

5. The choke according to claim 1, wherein the magnetic material is at least one or a combination of carbonyl iron powder (CIP), alloy iron powder, amorphous powder, nanocrystalline material, or sintered magnetic material.
